(19) United States
(12) Patent Application Publication
(10) Pub. No.: US 2016/0189713 A1
(43) Pub. Date: Jun. 30, 2016

(54) APPARATUS AND METHOD FOR AUTOMATICALLY CREATING AND RECORDING MINUTES OF MEETING

(71) Applicant: HON HAI PRECISION INDUSTRY CO., LTD., New Taipei (TW)

(72) Inventor: YOUNG-WAY LIU, New Taipei (TW)

(21) Appl. No.: 14/926,697

(22) Filed: Oct. 29, 2015

(30) Foreign Application Priority Data
Dec. 30, 2014 (TW) 103146227

(51) Int. Cl. G10L 15/26; G10L 25/93; G10L 15/07; G06F 17/24; G10L 17/00

(52) U.S. Cl. CPC G10L 15/265; G06F 17/248; G10L 17/005; G10L 15/07; G10L 25/93

(57) ABSTRACT

An electronic apparatus for automatically acquiring and revising minutes of a meeting and a method thereof includes the steps of identifying one or more speakers from audio signals which are recorded during a meeting, based on pre-sampled audio signals and a voice feature table stored in a non-transitory storage medium. The audio signals are converted to text and divided into paragraphs, one paragraph being attributable to one speaker, and each speaker has a given user name. An original minutes of the meeting, based on the text and a meeting minutes template stored in the non-transitory storage medium, is prepared and revised and issued to all relevant persons.

### CROSS-REFERENCE TO RELATED APPLICATIONS

This application claims priority to Taiwanese Patent Application No. 103146227 filed on Dec. 30, 2014, the contents of which are incorporated by reference herein.

### FIELD

The subject matter herein generally relates to data acquisition and recording.

### BACKGROUND

Interactive conferences (for example, conferences/meetings), may have multiple attendees. The multiple attendees can attend the conference at a same room or different rooms, at a same location or at different locations. The conference can be supported by a computer network having servers distributing content between participating client computers. During the course of a meeting, it is often helpful to create notes, or “action items” (“to-do” lists, other points for future reference). Generally, one attendee of the meeting is tasked with manually taking the notes/minutes of a meeting during the meeting, and distributing the notes/minutes of the meeting to the other attendees at the conclusion of the meeting. This manual technique is inconvenient for the note-taker/recorder, and may create incomplete or inaccurate notes/minutes of the meeting.

### BRIEF DESCRIPTION OF THE DRAWINGS

Implementations of the present technology will now be described, by way of example only, with reference to the attached figures.

FIG. 1 is a view of a running environment of one embodiment of an apparatus for automatically creating and recording minutes of a meeting.

FIG. 2 is a block diagram of one embodiment of an apparatus of FIG. 1.

FIG. 3 is a diagrammatic view showing an original minutes of meeting and an edited minutes of meeting created by the apparatus of FIG. 2.

FIG. 4 shows a flowchart of a method for automatically creating and recording minutes of a meeting, for the apparatus of FIG. 2, in accordance with a first embodiment.

FIG. 5 shows a flowchart of a method for automatically creating and recording minutes of a meeting, for the apparatus of FIG. 2, in accordance with a second embodiment.

FIG. 6 shows a flowchart of a method for automatically creating and recording minutes of a meeting, for the apparatus of FIG. 2, in accordance with a third embodiment.

FIG. 7 shows a flowchart of a method for automatically creating and recording minutes of a meeting, for the apparatus of FIG. 2, in accordance with a fourth embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented. It should be noted that references to “an” or “one” embodiment in this disclosure are not necessarily to the same embodiment, and such references mean “at least one.”

The word “module”, “unit” as used hereinafter, refers to logic embodied in hardware or firmware, or to a collection of software instructions, written in a programming language, such as, for example, Java, C, or assembly. One or more software instructions in the modules may be embedded in firmware, such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. Some non-limiting examples of non-transitory computer-readable media include CDs, DVDs, BLU-RAY, flash memory, and hard disk drives. The term “comprising,” when utilized, means “including, but not necessarily limited to”; it specifically indicates open-ended inclusion or membership in the so-described combination, group, series and the like.

The present disclosure is described in relation to an electronic apparatus and an electronic apparatus-based method for the electronic apparatus for automatically creating minutes of a meeting. The electronic device has at least one processor and a non-transitory storage medium coupled to the at least one processor and is configured to store instructions. The method includes the following steps: identifying, by the at least one processor, one or more users corresponding to audio signals of speech received during a meeting, based on the audio signals and a voice feature table stored in the non-transitory storage medium; converting, by the at least one processor, the audio signals of speech to a text comprising one or more user names of the identified one or more users, each user having a user name; and creating, by the at least one processor, an original minutes of the meeting according to the text and a meeting minutes template stored in the non-transitory storage medium.

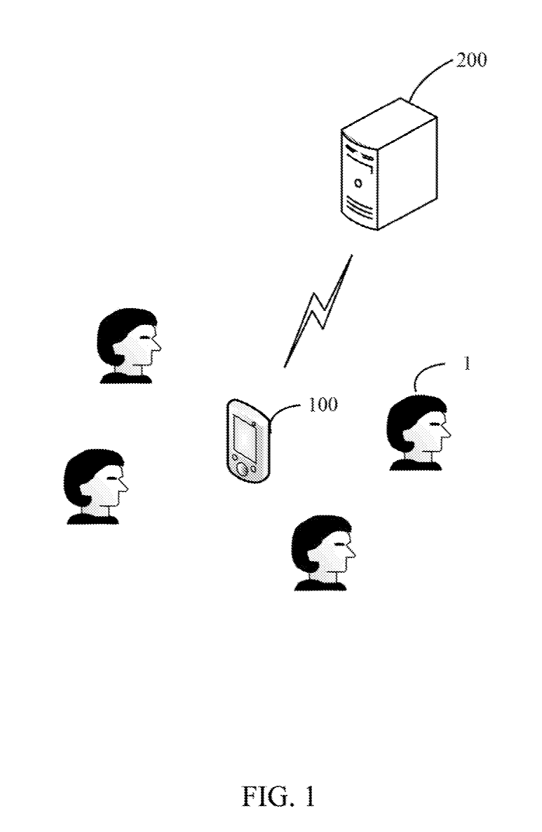

FIG. 1 shows an embodiment of an apparatus for automatically creating and recording minutes of a meeting. In at least the embodiment as shown in FIG. 1, an apparatus 100 for automatically creating and recording minutes of the meeting (hereinafter apparatus 100) can communicate with a cloud device 200. The apparatus 100 or one of several apparatus 100 is placed near each of multiple users 1. The apparatus 100 can hear speech of the multiple users 1 participating in a conference/meeting (hereinafter “meeting”). In an alternative embodiment, the apparatus 100 also can hear sound from a loudspeaker of a telephone located in an on-line meeting.

In at least one embodiment, the apparatus 100 and/or the cloud device 200 can have a function of creating meeting minutes, that is, can automatically create a minutes of the meeting based on the speech heard by the apparatus 100. The multiple users are the attendees of a meeting.

In at least one embodiment, the apparatus 100 has the function of creating meeting minutes, that is, the apparatus 100 can automatically create a minutes of the meeting based on the speech, independently of the cloud device 200. Specifically, for multiple attendees, the apparatus 100 can automatically record the speech received and identify a voice of each user 1. The apparatus 100 also can convert the speech to one or more texts, automatically create a minutes of the meeting based on the texts and a preset template, and automatically send a copy of the created minutes of the meeting to relevant persons. The relevant persons can include, and not be limited to, the users 1 and/or other persons, such as one or more executives of a to-do-list, and supervisors. Thus, the apparatus 100 implements the functions for automatically recording, creating, and sending minutes of the meeting.

In the at least one embodiment, the one or more texts also can include names of identified users. In other words, the apparatus 100 converts speech to the one or more texts including the names of identified users. The apparatus 100 also can identify names of the users 1 among the one or more texts. The apparatus 100 also can identify sound gaps, for example, natural silences between the words of a slow speaker, or silences as a result of hesitation, or actual or notional gaps between different speakers (hereinafter “unvoiced segments”) based on the received speech, and segment the received speech to a number of speech segments based on the identified one or more unvoiced segments. The apparatus 100 further can convert the number of speech segments to texts, and create a minutes of a meeting based on the texts and the preset template. The apparatus 100 also can automatically identify one or more words and/or phrases appearing repeatedly a preset number of times (hereinafter referred to as “common expressions”) in the speech and/or the texts, and store the common expressions in a phrasebook database. Thus, the apparatus 100 also can automatically revise the words and/or phrases of the one or more texts to common expressions during the process of creating the minutes of the meeting.

In an alternative embodiment, the apparatus 100 communicates with the cloud device 200. Thus, the apparatus 100 alone or together with the cloud device 200 can create minutes of the meeting based on the speech heard. The cloud device 200 alone also can create minutes of the meeting based on the speech received by and transmitted from the apparatus 100. In other words, the apparatus 100 records speech of users 1 during the meeting, converts the speech to corresponding audio signals and/or texts, and transmits the audio signals and/or texts to the cloud device 200. The apparatus 100 and/or the cloud device 200 can separately implement one or more of all the following functions, all of which functions can be implemented alone by the apparatus 100 in the above described embodiment. The speech of all users which is heard is converted into one or more texts, each user 1 is identified based on audio signals associated with the speech of a single user or based on the one or more texts (for example, identifying names of the users 1 among the one or more texts), one or more unvoiced segments based on the received speech and/or the one or more texts. The received speech and/or the one or more texts are segmented to a number of speech segments based on the identified one or more unvoiced segments and/or the one or more texts. A minutes of the meeting is automatically created based on the texts and the preset template, common expressions in the speech and/or the texts are identified and common expressions are stored in the phrasebook database. The words and/or phrases of the one or more texts are automatically revised to corresponding common expressions during the process of creating the minutes of the meeting, and the created minutes of meeting is automatically sent to relevant persons.

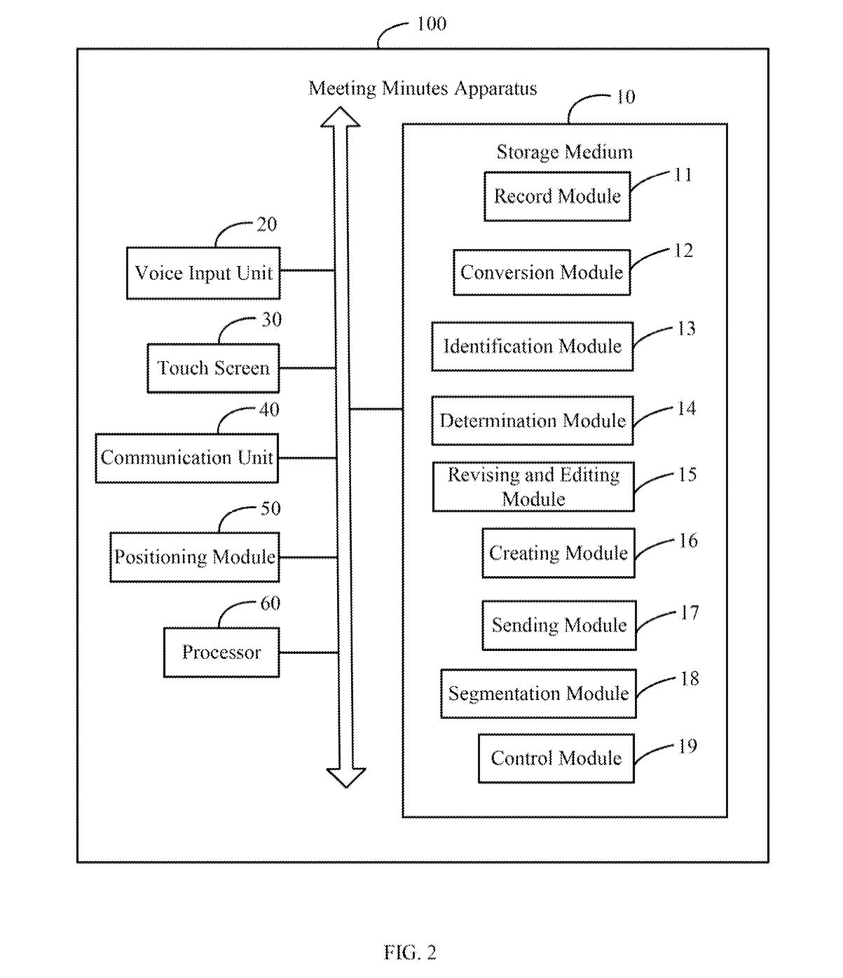

FIG. 2 is a block diagram of one exemplary embodiment of the apparatus 100 for automatically creating and recording minutes of the meeting. FIG. 2 only shows an exemplary embodiment. The apparatus 100 can include the function units/modules shown in FIG. 2, but there are various embodiments as stated above. Accordingly, the cloud device 200 can include the function units/modules, shown in FIG. 2, which are not included in the apparatus 100. All the function units/modules of the apparatus 100 which are shown in FIG. 2, according to the exemplary embodiment, can be included in the apparatus 100 of other embodiments, and others can be included in the cloud device 200 of the other embodiments. For example, if the cloud device 200 alone implements the functions for creating a minutes of the meeting in accordance with an embodiment, the apparatus 100 of the embodiment can include a voice input unit 20, a communication unit 40, and a processor 60 (shown in FIG. 2). The cloud device 200 can include a communication unit, a processor, and modules 12-19 stored in a storage medium (shown in FIG. 2). Different embodiments will be explained herein. In other embodiments the cloud device 200 can include all of the features so that it can cooperate with an apparatus 100 that has less features than another apparatus.

In at least one embodiment, the apparatus 100 can include, but is not limited to, a storage medium 10, a voice input unit 20, a touch screen 30, a communication unit 40, a positioning module 50, and at least one processor 60. The storage medium 10, the voice input unit 20, the touch screen 30, and the communication unit 40 connect to the at least one processor 60 via wires and cables. In at least one embodiment, the apparatus 100 can be a smart mobile phone or a portable computer. In alternative embodiments, the apparatus 100 also can be selected from the group consisting of a tablet computer, a laptop, a desktop, and a landline. FIG. 1 illustrates only one example of an apparatus that can include more or fewer components than illustrated, other examples can have a different configuration of the various components in other embodiments. The apparatus 100 also can include other components such as a keyboard and a camera.

In at least one embodiment, the voice input unit 20 can collect the speech of users 1 attending the meeting, and convert the collected speech to audio signals. The voice input unit 20 can be a microphone. The communication unit 40 can communicate with the cloud device 200 under the control of the processor 60. The positioning module 50 can provide real-time location information of the apparatus 100 by virtue of a global positioning satellite (GPS) positioning module.

In yet another embodiment, the apparatus 100 also can include a touch screen 30.

In at least one embodiment, the apparatus 100 can independently and automatically create minutes of the meeting. The apparatus 100 automatically converts speech heard by the voice input unit 20 to one or more passages of text. The speech received by the voice input unit 20 is spoken by the user(s) 1 attending the meeting. The apparatus 100 also automatically creates a minutes of the meeting based on the speech/texts and a preset meeting minutes template. Specifically, the apparatus 100 can convert speech to one or more texts, identify each user 1 based on audio signals representing the speech or based on the one or more texts (eg. identifying names of the users 1 among the one or more texts) and identify one or more unvoiced segments based on the received speech and/or the one or more texts. The apparatus 100 can attribute the received speech and/or passages of text and identify the actual speaker based on identification of the unvoiced segments and/or the text. A minutes of the meeting based on the texts and the preset template can be automatically created, common expressions in the speech and/or texts can be identified, and the common expressions can be stored in the phrasebook database. The words and/or phrases of the one or more texts can be automatically revised to corresponding common expressions during the creating process for the minutes of the meeting. The apparatus 100 also can automatically send the created minutes of the meeting and/or the to-do-list to relevant persons in a predetermined manner In at least one embodiment, the predetermined manner is selected from a group consisting of a predetermined sending format and a predetermined sending at a point in time/during a period of time. The contact information of relevant persons is selected from the group consisting of E-mail addresses, telephone number, and social accounts (eg. QQ account, WE-CHAT account, and the like.)

The storage medium 10 can store a voice feature table mapping a relationship between a number of user names and a number of features of speech of each of the users. In at least one embodiment, the user name can be a real name, a nickname, or a code of the user. The content of the voice feature table can be obtained and recorded by for example sampling each user before the meeting is started. The storage medium 10 also can store a preset meeting minutes template preset by the user or the system of the apparatus 100. Also, the storage medium 10 also can store speech data/voice data recorded by the apparatus 100, a speech and text database which can be used during the speech and conversion to text process, and the phrasebook database. The phrasebook database can be filtered, added to, and stored during the process of the apparatus 100 executing the function of creating meeting minutes. In an alternative embodiment, the phrasebook database can be downloaded from a database on the internet or from a computerized device, such as a server.

The storage medium 10 can include various types of non-transitory computer-readable storage mediums. For example, the storage medium 10 can be an internal storage system, such as a flash memory, a random access memory (RAM) for temporary storage of information, and/or a read-only memory (ROM) for permanent storage of information. The storage medium 10 can also be an external storage system, such as a hard disk, a storage card, or a data storage medium. The at least one processor 60 can be a central processing unit (CPU), a microprocessor, or other data processor chip that performs functions of creating the minutes of the meeting in the apparatus 100.

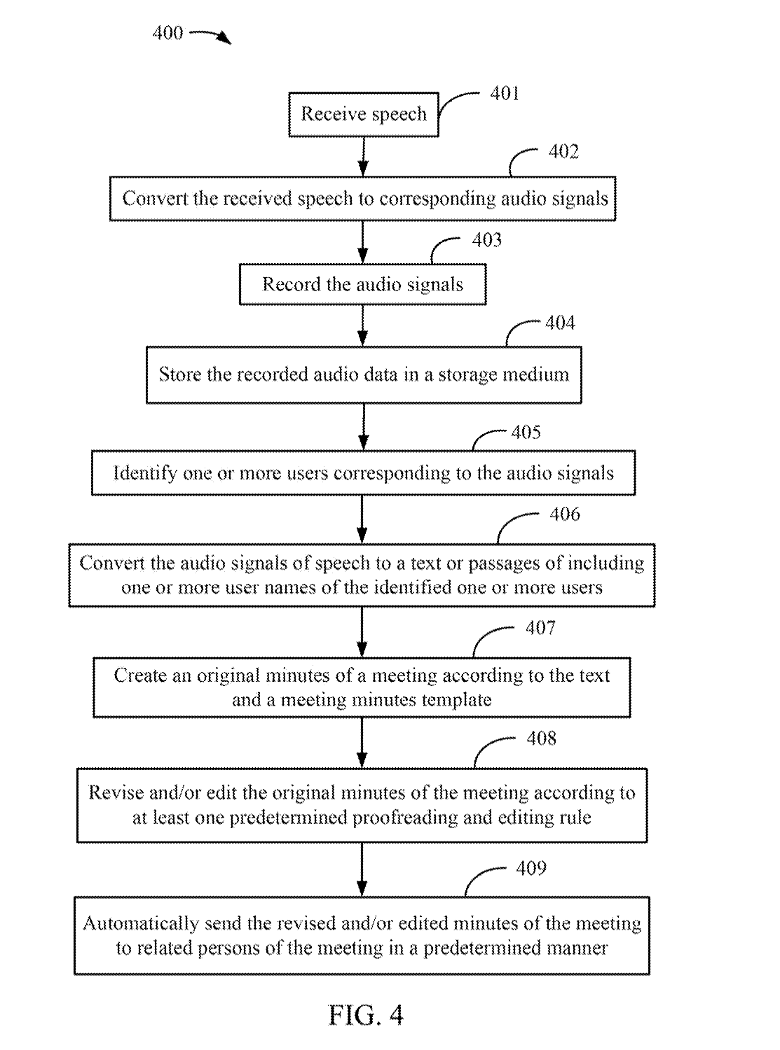

In at least one embodiment, the storage medium 10 also can store a number of function modules which can include computerized codes in the form of one or more programs. The number of function modules can be configured to be executed by one or more processors (such as the processor 60). For example, referring to FIG. 1, the storage medium 10 stores a record module 11, a conversion module 12, an identification module 13, a determination module 14, a revising and editing module 15, a creating module 16, a sending module 17, a segmentation module 18, and a control module 19. The function modules 11-19 can include computerized codes in the form of one or more programs which are stored in the storage medium 10. The processor 60 executes the computerized codes to provide functions of the function modules 11-19. The functions of the function modules 11-19 are illustrated in the flowchart descriptions of FIGS. 4-7.

In alternative embodiments, the function modules stored in the storage medium 10 can be varied according to actual conditions of the apparatus 100. For example, in at least one embodiment, it is the cloud device 200 which executes one or more of the following functions, instead of the apparatus 100 as in the previously described embodiment(s). The speech is converted to one or more passages of text, and each user 1 is identified based on audio signals associated with the speech or based on the one or more texts (eg. identifying names of the users 1 among the one or more texts). One or more unvoiced segments are identified based on the received speech and/or the one or more passages of text, the received speech and/or the attributed text. A minutes of meeting based on the texts and the preset template is automatically created and common expressions in the speech and/or the texts are identified, the common expressions being stored in the phrasebook database. The words and/or phrases of the one or more texts are automatically revised to corresponding common expressions during the creating process for the minutes of the meeting. The created minutes of the meeting are automatically sent to relevant persons. Accordingly, the cloud device 200 can store one or more function modules, so the storage medium 10 of the apparatus 100 is not required to store any function modules which are stored in the cloud device 200.

For ease of disclosure, the following descriptions regarding the methods for automatically creating minutes of the meeting are illustrated based on the premise that the methods are running in a meeting minutes apparatus (eg. the apparatus 100). The apparatus 100 also includes one or more function modules corresponding to the actual functions. According to the previous description, one or more blocks of each of the following methods for automatically creating minutes of the meeting can be executed by a cloud device (eg. the cloud device 200) communicating with the apparatus 100. As many as necessary of the following blocks can be added to the following described methods for automatically creating minutes of the meeting. The apparatus 100 transmits the audio signals of speech/text representing speech and/or other data to the cloud device 200. The cloud device 200 receives the signals/text transmitted from the apparatus 100. One of ordinary skill in the art can obtain these techniques elsewhere, thus detailed descriptions of the transmitting and the receiving processes are omitted.

FIG. 4 is a flowchart of a method for automatically creating minutes of the meeting that is presented in accordance with a first exemplary embodiment. A method 400 for automatically creating minutes of the meeting is provided by way of example, as there are a variety of ways to carry out the method. The method 400 described below can be carried out using the configurations illustrated in FIG. 2 and various elements of these figures are referenced in explaining example method 400. The method 400 can be run on a meeting minutes apparatus (such as the apparatus 100) and/or a cloud device (such as the cloud device 200). Each block shown in FIG. 2 represents one or more processes, methods, or routines, carried out in the exemplary method 400. Furthermore, the illustrated order of blocks is by example only and the order of the blocks can change. Additional blocks may be added or fewer blocks may be utilized, without departing from this disclosure. Depending on the embodiment, additional steps can be added, others removed, and the ordering of the steps can be changed. The exemplary method 400 can begin at block 401, 403, or 405.

At block 401, a voice input unit receives speech. In at least one embodiment, the apparatus 100 or one of a number of apparatus 100 is placed near each of multiple users 1 attending the meeting. The voice input unit 20 is a microphone arranged in the apparatus 100.

At block 402, a voice input unit converts the received speech to corresponding audio signals.

In an alternative embodiment, another block can be executed concurrently with block 402 or before block 402 is executed. The other block provides a control module activating a positioning module to obtain location information of the apparatus 100 and time information of the current meeting, the obtained location and time information being stored in a storage medium. In other embodiments, the apparatus 100 can also receive information about the meeting via a touch screen input, for example, the date, time, location and names of attendees of the meeting.

At block 403, a record module records the audio signals.

At block 404, a record module stores the recorded audio data in a storage medium. In at least one embodiment, blocks 403 and 404 can be omitted in response to a user's selection, and block 405 is executed after block 402.

At block 405, an identification module identifies one or more users corresponding to the audio signals, based on the audio signals and a voice feature table. In at least one embodiment, the voice feature table is stored in the storage medium 10 and maps relationships between a number of user names and a number of speech features of the users.

In at least one embodiment, the identification module 13 analyzes the audio signals to obtain one or more voice features, and retrieves one or more users having the same or most similar voice features. These are compared to the obtained one or more voice features recorded in the voice feature table. Therefore, if more than one user speaks during the meeting, the identification module 13 can identify the speaker associated with the audio signals based on the audio signals and the voice feature table.

In an alternative embodiment, the identification module 13 also can label speech of different users with different labels, and apply the labels accordingly.

At block 406, a conversion module converts the audio signals of speech to a text or passages of text including one or more user names of the identified one or more users, each user having a user name. In at least one embodiment, the conversion module 12 converts the speech to text based on the audio signals and speech and text database stored in the storage medium 10, and can automatically add a speaker name on a predetermined region of the text. In at least one embodiment, the predetermined region can be the first part of a passage of text.

In an alternative embodiment, if the identification module 13 has added one or more labels, the text output by the conversion module 12 also can include the labels.

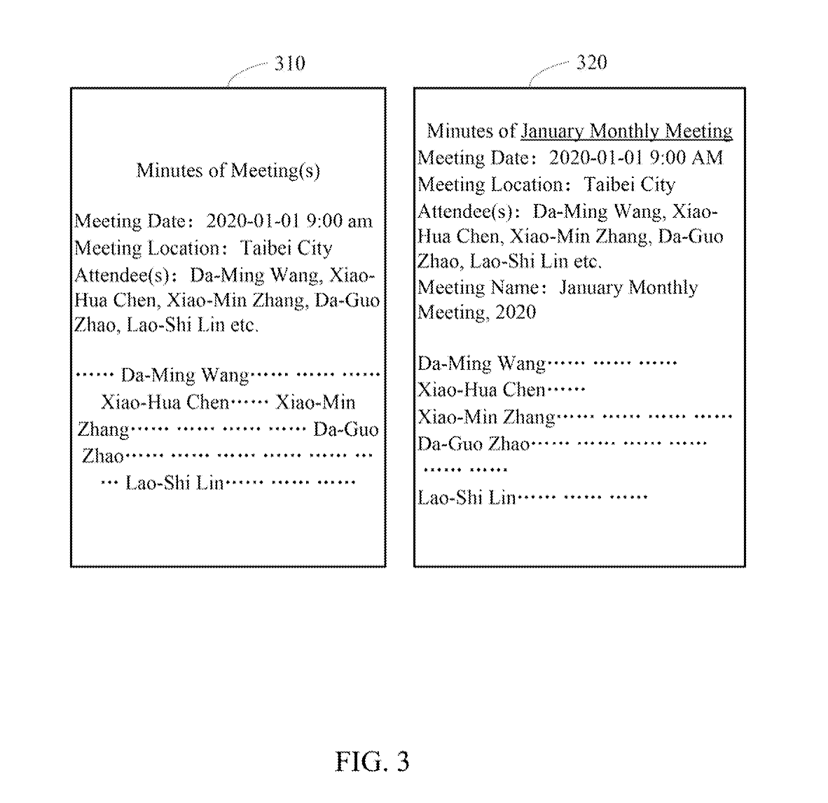

At block 407, a creating module creates an original minutes of a meeting according to the text and a meeting minutes template. In at least one embodiment, the meeting minutes template is pre-stored in the storage medium 10. Referring to FIG. 3, original minutes 310 of the meeting created by the creating module 16 are shown, in accordance with an exemplary embodiment.

In at least one embodiment, the creating module 16 automatically adds the location and instant time information of the apparatus 100 to the created original minutes of the meeting. For example, the creating module 16 can add the instant time information of the meeting on a meeting date/time column of the meeting minutes template, and add the location information of the apparatus 100 on a meeting location column of the meeting minutes template.

In yet another embodiment, the creating module 16 also can add user names of attendees input via the touch screen 30 by a user on an attendee column of the meeting minutes template.

In an alternative embodiment, the creating module 16 also can add user names of attendees identified by the identification module 13 on the attendee column of the meeting minutes template. The user names of attendees can be identified, based on text of audio signals or audio signals themselves, by the identification module 13.

At block 408, a revising and editing module revises and/or edits the original minutes of the meeting according to at least one predetermined revising and editing rule, to obtain a minutes of the meeting.

In at least one embodiment, the at least one predetermined revising and editing rule is to divide the text into one or more passages or paragraphs, at the beginning of each is name of an attendee of the meeting. The identification module 13 can also identify user names from the text. The revising and editing module 15 divides the text to one or more passages or paragraphs in the original minutes of the meeting. In at least one embodiment, the revising and editing module 15 creates a division of the text at the first character or the last character of the name. For example, if the text includes a name such as Da-Ming Wang, the revising and editing module 15 inserts “Da-Ming Wang” as the beginning of a paragraph or passage.

Preferably, the user names described here are all identified by the identification module 13 based on audio signals. In an alternative embodiment, the user names also can be identified by the identification module 13 based on the text of the audio signals and user names stored in the storage medium 10. Referring to FIG. 3, a minutes 320 of the meeting revised and/or edited by the revising and editing module 15 based an original minutes of the meeting is shown.

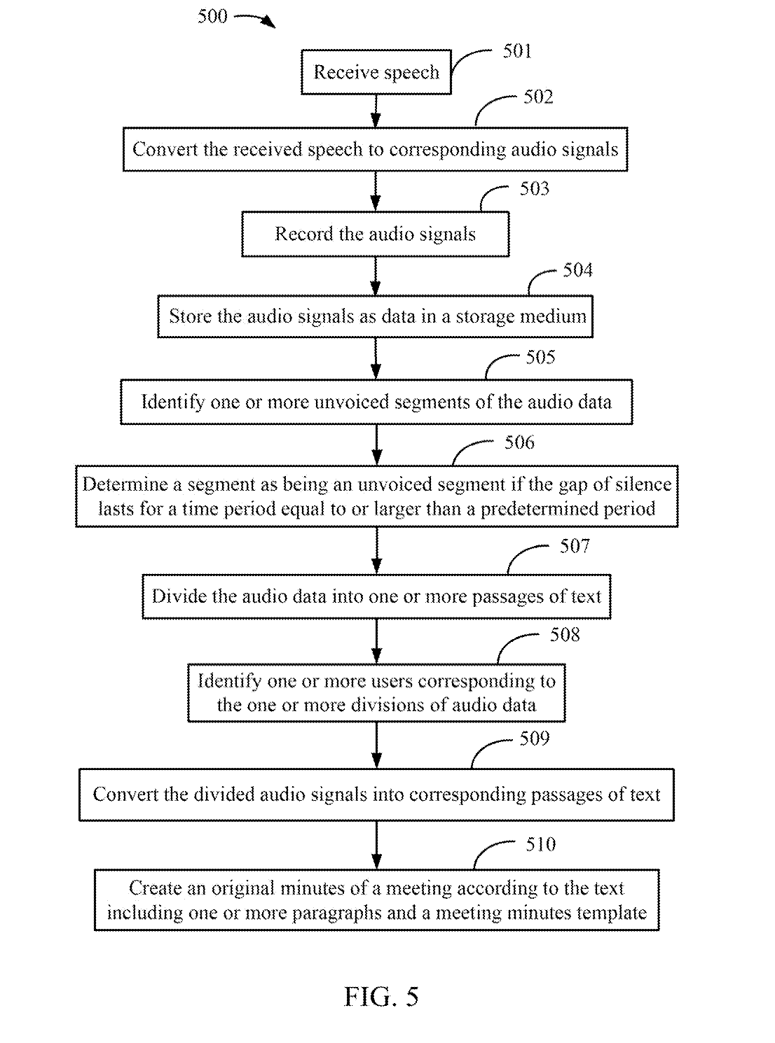

In an alternative embodiment, the at least one predetermined revising and editing rule is to create paragraphs or passages of text corresponding to each speaker based on the labels added by the identification module 13. In detail, if the identification module 13 has added a label to each speaker, the revising and editing module 15 creates a division in the text of at least one paragraph associated with that speaker. In an alternative embodiment, the at least one predetermined revising and editing rule can also include intelligently identifying and correcting words which are incorrect due to mispronounciation and words used ungrammatically (hereinafter “text requiring recalibration”), details will be illustrated in accordance with FIG. 5.

In yet another embodiment, the revising and editing module 15 also stores the revised and/or edited minutes of the meeting (eg. the minutes 320 of the meeting shown in FIG. 3) in the storage medium 10. A sending module 17 also can control a communication unit 40 to send the revised and/or edited minutes of the meeting to the cloud device 200, controlling the cloud device 200 to store the revised and/or edited minutes of the meeting.

In at least one embodiment, the revising and editing module 15 further edits the original minutes of the meeting in response to editing signals from the touch screen 30. For example, a user can input edits of the original minutes of the meeting via the touch screen 30. In other words, the apparatus 100 provides a function for manually editing the original minutes of the meeting for a user.

At block 409, a sending module automatically sends the revised and/or edited minutes of the meeting to related persons of the meeting in a predetermined manner.

In at least one embodiment, the predetermined manner can include immediately sending the revised and/or edited minutes of the meeting (created minutes of the meeting) after the minutes of the meeting is created (revised and/or edited) to the related persons. The predetermined manner can also include sending the revised and/or edited minutes of the meeting within a predetermined period of time or at a specific time point after the minutes of the meeting is created, to the related persons. The contact information of related persons are selected from the group consisting of: E-mail addresses, telephone number, social accounts (eg. QQ account, WE-CHART account, etc.)

In an alternative embodiment, the predetermined manner can include sending a TO-DO-LIST based on the minutes of the meeting to related persons in a predetermined manner, at a predetermined time point/during a time period, or together with the created minutes of the meeting. For example, the sending module 17 can send the to-do-list from the minutes of the meeting at a predetermined day before a deadline set by the to-do-list item, to the persons associated with the to-do-list. The persons associated with the to-do-list can include, but not be limited to, the person in charge of an item of the to-do-list or the supervisor of the to-do-list. In an alternative embodiment, the created minutes of the meeting can also be sent together with the to-do-list.

In at least one embodiment, block 409 can be omitted, and a user can send the created minutes of the meeting manually. If the cloud device 200 receives and stores the created minutes of the meeting, the created minutes of the meeting also can be automatically sent by the cloud device 200.

FIG. 5 is a flowchart of a method for automatically creating minutes of a meeting that is presented in accordance with a second exemplary embodiment. A method 500 for automatically creating minutes of the meeting is provided by way of example, as there are a variety of ways to carry out the method. The method 500 described below can be carried out using the configurations illustrated in FIG. 2 and various elements of these figures are referenced in explaining example method 500. The method 500 can be run on a meeting minutes apparatus (such as the apparatus 100) and/or a cloud device (such as the cloud device 200). Each block shown in FIG. 2 represents one or more processes, methods, or routines, carried out in the exemplary method 500. Furthermore, the illustrated order of blocks is by example only and the order of the blocks can change. Additional blocks may be added or fewer blocks may be utilized without departing from this disclosure. Depending on the embodiment, additional steps can be added, others removed, and the ordering of the steps can be changed.

It is to be understood, some of the steps/blocks of the method 500 shown in FIG. 5 can be the same or similar to those of the method 400 described above, thus the descriptions for the steps/blocks described above, concurrently executed, can also be applied in method 500. Detail descriptions given previously are not repeated. The exemplary method 500 can begin at block 501.

At block 501, a voice input unit receives speech.

At block 502, a voice input unit converts the received speech to corresponding audio signals.

At block 503, a record module records the audio signals.

At block 504, a record module stores the audio signals as data in a storage medium. In at least one embodiment, blocks 503 and 504 can be omitted in response to a user's selection, and block 505 is executed after block 502.

At block 505, an identification module identifies one or more unvoiced segments of the audio data. In at least one embodiment, the one or more unvoiced segments are gaps of silence among the audio data.

In at least one embodiment, the one or more unvoiced segments are identified by the identification module 13 as having a volume value smaller than a predetermined threshold value. Where one speaker interrupts another, leaving no discernible sound gap, the identification module 13 can also identify a change of speaker by differences between the characteristics of the two voices.

In an alternative embodiment, if the method 500 excludes block 503, the identification module 13 can identify unvoiced segments among all the speech according to the audio signals, the recorded audio data not being required for this purpose.

At block 506, a determination module can determine a segment as being an unvoiced segment if the gap of silence lasts for a time period equal to or larger than a predetermined period. The determined unvoiced segment which has a gap of silence lasting for the time period equal to or larger than a predetermined period is deemed a satisfactory unvoiced segment. In at least one embodiment, the number of satisfactory unvoiced segment can be more than one, and the predetermined period is three seconds. In alternative embodiments, the predetermined period can be set according to need.

At block 507, a segmentation module can divide the audio data into one or more passages of text according to the satisfactory unvoiced segment(s). In at least one embodiment, the segmentation module 18 creates a new division at each satisfactory unvoiced segment. If more than one sequential unvoiced segments are satisfactory unvoiced segments, namely, more than one unvoiced segments each lasts for a time period larger than the predetermined period, the segmentation module 18 creates more than one division of the audio data, with each division attributed to a number of corresponding divisions of audio data according to the unvoiced segments which are satisfactory.

At block 508, an identification module identifies one or more users corresponding to the one or more divisions of audio data, based on the audio signals and a voice feature table. In at least one embodiment, the voice feature table is stored in the storage medium 10 and maps a relationship between a number of user names and a number of speech features.

In an alternative embodiment, the method 500 can exclude block 508.

At block 509, a conversion module converts the divided audio signals into corresponding passages of text.

In at least one embodiment, the conversion module 12 converts the divided audio signals into corresponding passages or paragraphs of text based on the divided audio signals. The one or more speakers can be identified by the identification module 13, and by reference to a speech and text database stored in the storage medium 10.

At block 510, a creating module creates an original minutes of a meeting according to the text including one or more paragraphs and a meeting minutes template. In at least one embodiment, the meeting minutes template is pre-stored in the storage medium 10. The detail of the embodiment for executing clock 510 can be the same or similar to that of the block 407 of the method 400 and are not repeated here.

In at least one embodiment, blocks 407 and 408 of the method 400 can be executed after block 510 for the method 500.

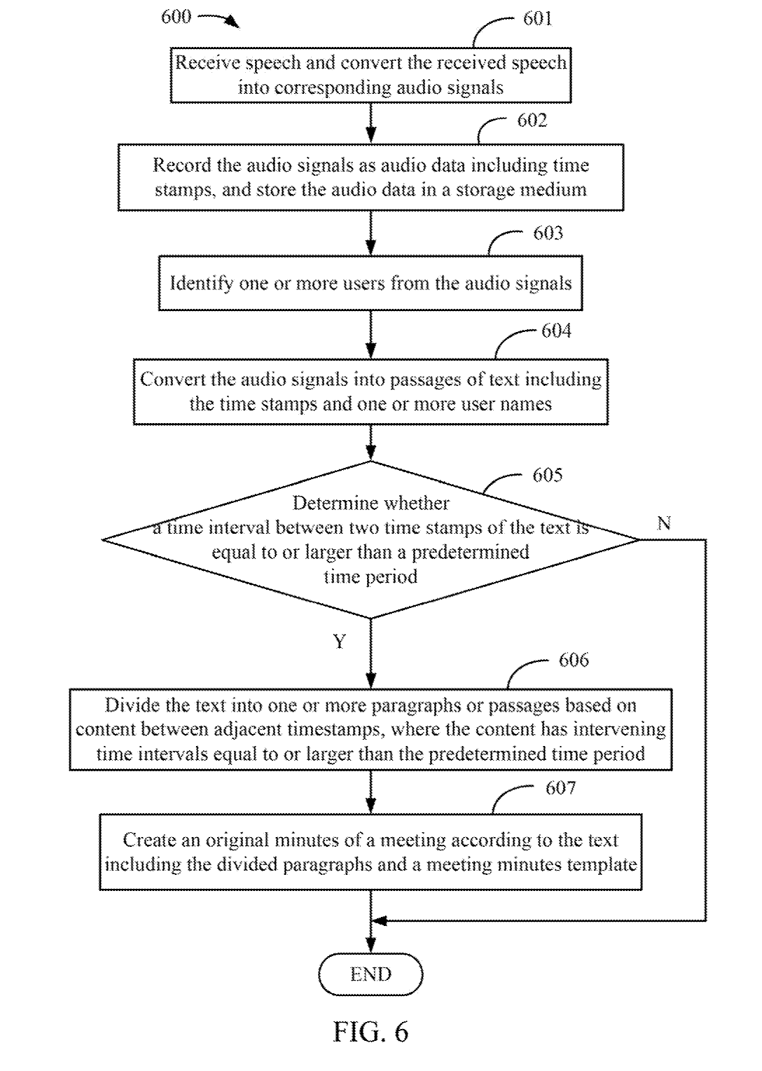

FIG. 6 is a flowchart of a method for automatically creating minutes of a meeting that is presented in accordance with a third exemplary embodiment. A method 600 for automatically creating minutes of the meeting is provided by way of example, as there are a variety of ways to carry out the method. The method 600 described below can be carried out using the configurations illustrated in FIG. 2 and various elements of these figures are referenced in explaining example method 600. The method 600 can be run on a meeting minutes apparatus (such as the apparatus 100) and/or a cloud device (such as the cloud device 200). Each block shown in FIG. 2 represents one or more processes, methods, or routines, carried out in the exemplary method 600. Furthermore, the illustrated order of blocks is by example only and the order of the blocks can change. Additional blocks may be added or fewer blocks may be utilized, without departing from this disclosure. Depending on the embodiment, additional steps can be added, others removed, and the ordering of the steps can be changed.

A number of steps/blocks of the method 600 shown in FIG. 5 can be the same or similar to those of the methods 400 and 500 described above. The descriptions of any repeated steps/blocks, concurrently executed, can also be applied in method 600. The detail descriptions are not repeated. The exemplary method 600 can begin at block 601.

At block 601, a voice input unit receives speech and converts the received speech into corresponding audio signals.

At block 602, a record module records the audio signals as audio data including timestamps, and stores the audio data in a storage medium. In at least one embodiment, block 602 can be omitted in response to a user's selection, and block 603 is executed after block 601.

At block 603, an identification module identifies one or more users from the audio signals. In at least one embodiment, the voice feature table is stored in the storage medium 10 and maps a relationship between a number of user names and a number of speech features of the users. The identification module 13 identifies one or more users corresponding to the audio signals from the recorded audio data including timestamps and the voice feature table.

In an alternative embodiment, block 603 also can be omitted.

At block 604, a conversion module converts the audio signals into passages of text including the timestamps and one or more user names.

In at least one embodiment, the conversion by the conversion module 12 automatically adds speaker names of the one or more identified speakers at the front of each passage of text attributed to a speaker, including the timestamps.

In an alternative embodiment, the conversion module 12 converts the audio signals to text including timestamps, based on the audio signals, referring to the speech and text database stored in the storage medium 10.

At block 605, a determination module determines whether a time interval between two timestamps of the text is equal to or larger than a predetermined time period. If yes, block 606 is executed, otherwise, the process ends. In at least one embodiment, the predetermined time period is three seconds. More than one such time interval may exist between neighboring timestamps. In other words, there may be a number of neighboring timestamps which are separated by more than the predetermined time period. In alternative embodiments, the predetermined period can be set according to need.

At block 606, a segmentation module divides the text into one or more paragraphs or passages based on content between adjacent timestamps, where the content has intervening time intervals equal to or larger than the predetermined time period.

In at least one embodiment, content which includes a timestamp separated from a neighboring timestamp by a time interval longer than the predetermined time period is divided into two paragraphs or passages, at the point in time of the timestamp. In other words, the first and second parts of the content are divided into separate paragraphs, each of which may be attributed to a different speaker, unless an unvoiced segment requires otherwise.

At block 607, a creating module creates an original minutes of a meeting according to the text including the divided paragraphs and a meeting minutes template. In at least one embodiment, the meeting minutes template is pre-stored in the storage medium 10. The detail of the embodiment for executing block 607 can be the same or similar to that of block 509 of the method 500.

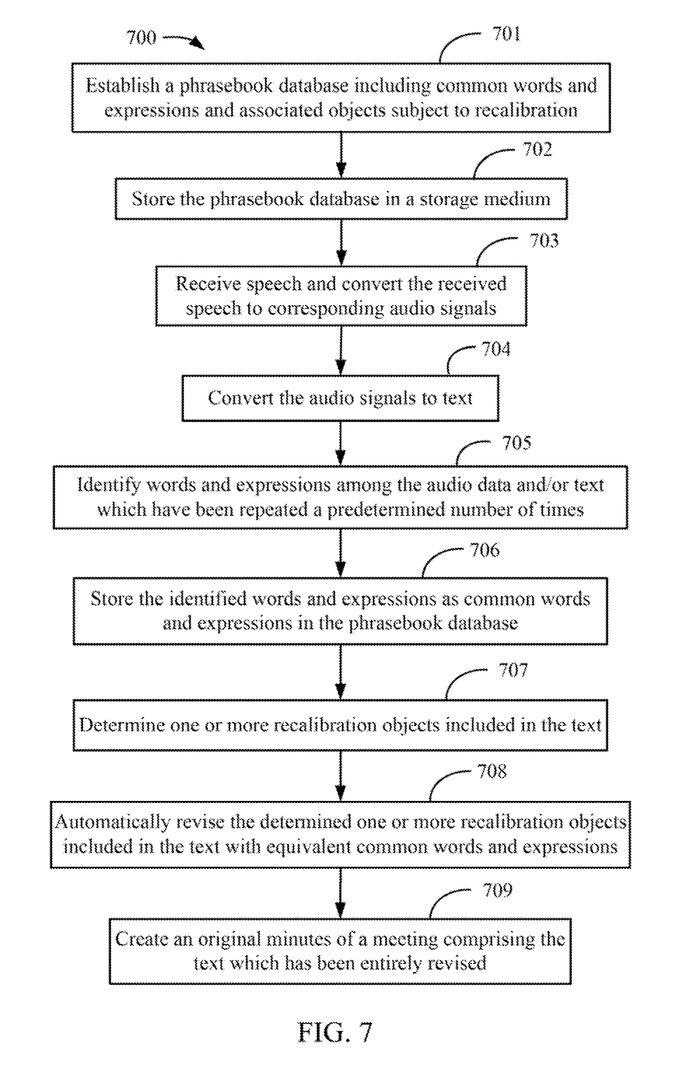

FIG. 7 is a flowchart of a method for automatically creating minutes of a meeting that is presented in accordance with a third exemplary embodiment. A method 700 for automatically creating minutes of the meeting is provided by way of example, as there are a variety of ways to carry out the method. The method 700 described below can be carried out using the configurations illustrated in FIG. 2 and various elements of these figures are referenced in explaining example method 700. The method 700 can be run on a meeting minutes apparatus (such as the apparatus 100) and/or a cloud device (such as the cloud device 200). Each block shown in FIG. 2 represents one or more processes, methods, or routines, carried out in the exemplary method 700. Furthermore, the illustrated order of blocks is by example only and the order of the blocks can change. Additional blocks may be added or fewer blocks may be utilized, without departing from this disclosure. Depending on the embodiment, additional steps can be added, others removed, and the ordering of the steps can be changed.

Some of the steps/blocks of the method 700 shown in FIG. 7 can be the same or similar to those of the methods 400 and 500 described above, thus the detail descriptions for the steps/blocks described above, concurrently executed, can also be applied in method 700. The detail descriptions are not repeated. The exemplary method 700 can begin at block 701.

At block 701, a control module establishes a phrasebook database including common words and expressions and associated objects subject to recalibration (hereinafter “recalibration object”). In at least one embodiment, each of the common words and expressions is associated with at least one recalibration object. The recalibration object can be improper or unsatisfactory/words and/or expressions in the text. In other words, the recalibration object is actually not the word and/or expression that a user would have wanted. The recalibration object needs to be revised and/or replaced by a common word and/or expression associated with the recalibration object.

In at least one embodiment, the control module 19 automatically establishes the phrasebook database when the apparatus 100 is executing the function for automatically creating minutes of the meeting for a first time. The phrasebook database maps a relationship between at least one common word or expression and an associated recalibration object(s). Each common word (or expression) is associated with at least one recalibration object. The common words and expressions are selected from the group consisting of common words, common phrases, common expressions, and common sentences. The common words and expressions can be in audible or written form. The recalibration objects can be manually edited by a user. The recalibration objects are selected from the group consisting of: characters, words, expressions, phrases, and sentences.

At block 702, a control module stores the phrasebook database in a storage medium.

In an alternative embodiment, blocks 701 and 702 can be omitted in the method 700. Instead, the apparatus 100 pre-stores the phrasebook database. The phrasebook database can be filtered, accumulated, and stored as the apparatus 100 executes the function of creating meeting minutes. The phrasebook database also can be downloaded from an internet database or a computerized device such as a server.

At block 703, a voice input unit receives speech and converts the received speech to corresponding audio signals.

At block 704, a conversion module converts the audio signals to text.

In at least one embodiment, between block 703 and block 704, the method 700 can also execute blocks described above in methods 400, 500, and 600. For example, the block(s) for converting audio signals to text are also executed.

At block 705, an identification module identifies words and expressions among the audio data and/or text which have been repeated a predetermined number of times.

At block 706, an identification module stores the identified words and expressions as common words and expressions in the phrasebook database. In at least one embodiment, the identified words and expressions can be selected from words, expressions, phases, and sentences in spoken speech and/or text. The predetermined number of times can be twenty times. In an alternative embodiment, the predetermined number of times can vary according to actual need. Blocks 705 and 706 can also be omitted in the method 700.

At block 707, a determination module determines one or more recalibration objects included in the text.

At block 708, a revising and editing module automatically revises the determined one or more recalibration objects included in the text with equivalent common words and expressions, according to the phrasebook database.

At block 709, a creating module creates an original minutes of a meeting comprising the text which has been entirely revised. In at least one embodiment, the meeting minutes template utilized in the revising is pre-stored in the storage medium 10. The detail embodiments for executing clock 707 can be the same or similar to that of block 510 of the method 500 and are thus omitted here. In at least one embodiment, block 706 can be executed after the execution of block 707.

The embodiments shown and described above are only examples. Many details are often found in the art such as the other features of an apparatus and a method for acquiring and recording data. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An electronic apparatus-based method for automatically creating minutes of a meeting, the electronic device having at least one processor and a non-transitory storage medium coupled to the at least one processor and configured to store instructions, the method comprising:
identifying, by the at least one processor, one or more users corresponding to audio signals of speech received during a meeting, based on the audio signals and a voice feature table stored in the non-transitory storage medium;
converting, by the at least one processor, the audio signals of speech to a text comprising one or more user names of the identified one or more users, each user having a user name; and
creating, by the at least one processor, an original minutes of the meeting according to the text and a meeting minutes template stored in the non-transitory storage medium.

2. The method as claimed in claim 1, further comprising: editing the original minutes of the meeting according to at least one predetermined revising and editing rule, to obtain a minutes of the meeting.

3. The method as claimed in claim 2, wherein the at least one predetermined revising and editing rule is to divide the text into one or more passages or paragraphs, at the beginning of each is user name of an attendee of the meeting.

4. The method as claimed in claim 2, further comprising:
recording the audio signals, and storing the recorded audio data in the non-transitory storage medium; and
automatically sending the edited minutes of the meeting to related persons of the meeting in a predetermined manner.

5. The method as claimed in claim 4, wherein:
the at least one predetermined revising and editing rule is to create paragraphs or passages of text corresponding to each speaker according to divisions of the audio data; and
the method further comprises:
identifying unvoiced segments among the audio data; and
dividing the audio data into one or more divisions of audio data according to at least one satisfactory unvoiced segment, if a gap of silence of the at least one satisfactory unvoiced segment lasts for a time period equal to or larger than a predetermined period.

6. The method as claimed in claim 4, further comprising:
determining one or more recalibration objects included in the text; and
automatically revising the determined one or more recalibration objects included in the text with equivalent common words and expressions, according to a phrasebook database.

7. The method as claimed in claim 6, further comprising:
identifying words and expressions among the audio data and text which have been repeated a predetermined number of times; and
storing the identified words and expressions as common words and expressions in the phrasebook database.

8. The method as claimed in claim 1, wherein the “converting” comprises:
converting the audio signals to a text based on the audio signals associated with the speech and a speech and text database stored in the non-transitory storage medium; and
automatically adding one or more corresponding user names on a predetermined region of the text.

9. The method as claimed in claim 1, wherein the “creating” further comprises:
automatically adding location information of the electronic apparatus and time information of the meeting obtained by an positioning module of the electronic apparatus to the original minutes of the meeting.

10. The method as claimed in claim 1, further comprising:
identifying one or more user names among the text, or identifying one or more user names of the one or more users had the speech based on the audio signals; and
adding the identified one or more user names on an attendee column of the meeting minutes template.

11. An electronic apparatus for automatically creating minutes of a meeting, comprising:
at least one processor; and
a non-transitory storage medium coupled to the at least one processor and storing one or more programs, which when executed by the at least one processor, cause the at least one processor to:
identify one or more users corresponding to audio signals of speech received during a meeting, based on the audio signals and a voice feature table stored in the non-transitory storage medium;
convert the audio signals of speech to a text comprising one or more user names of the identified one or more users, each user having a corresponding user name; and
create an original minutes of the meeting according to the text and a meeting minutes template stored in the non-transitory storage medium.

12. The electronic apparatus as claimed in claim 11, wherein the one or more programs cause the at least one processor to further: edit the original minutes of the meeting according to at least one predetermined revising and editing rule, to obtain a minutes of the meeting.

13. The electronic apparatus as claimed in claim 12, wherein the at least one predetermined revising and editing rule is to divide the text into one or more passages or paragraphs, at the beginning of each is user name of an attendee of the meeting.

14. The electronic apparatus as claimed in claim 12, wherein the one or more programs cause the at least one processor to further:
record the audio signals, and store the recorded audio data in the non-transitory storage medium; and
automatically send the edited minutes of the meeting to related persons of the meeting in a predetermined manner.

15. The electronic apparatus as claimed in claim 14, wherein:
the at least one predetermined revising and editing rule is to to create paragraphs or passages of text corresponding to each speaker according to divisions of the audio data; and
the one or more programs cause the at least one processor to further:
identify unvoiced segments among the audio data; and
divide the audio data into one or more divisions of audio data according to at least one satisfactory unvoiced segment, if a gap of silence of the at least one satisfactory unvoiced segment lasts for a time period equal to or larger than a predetermined period.

16. The electronic apparatus as claimed in claim 14, wherein the one or more programs cause the at least one processor to further:
determine one or more recalibration objects included in the text; and
automatically revise the determined one or more recalibration objects included in the text with equivalent common words and expressions, according to a phrasebook database.

17. The electronic apparatus as claimed in claim 16, wherein the one or more programs cause the at least one processor to further:
identify words and expressions among the audio data and/or text which have been repeated a predetermined number of times; and
store the identified words and expressions as common words and expressions in the phrasebook database.

18. The electronic apparatus as claimed in claim 11, wherein the one or more programs cause the at least one processor to further:
convert the audio signals to a text based on the audio signals associated with the speech and a speech and text database stored in the non-transitory storage medium; and
automatically add one or more corresponding user names on a predetermined region of the text.

19. The electronic apparatus as claimed in claim 11, wherein the one or more programs cause the at least one processor to further:
automatically add location information of the electronic apparatus and time information of the meeting obtained by an positioning module of the electronic apparatus to the original minutes of the meeting.

20. The electronic apparatus as claimed in claim 11, wherein the one or more programs cause the at least one processor to further:
identify one or more user names among the text, or identify one or more user names of the one or more users had the speech based on the audio signals; and
add the identified one or more user names on an attendee column of the meeting minutes template.
